(19) United States
(12) Patent Application Publication
(10) Pub. No.: US 2015/0035288 A1
(43) Pub. Date: Feb. 5, 2015

(54) APPARATUS FOR LOCKING A LID TO A BODY OF A CONTAINER

(71) Applicants: Armin Fink, Ocoee, FL (US); Joseph Oliva, Vero Beach, FL (US)

(72) Inventors: Armin Fink, Ocoee, FL (US); Joseph Oliva, Vero Beach, FL (US)

(21) Appl. No.: 14/314,288

(22) Filed: Jun. 25, 2014

Related U.S. Application Data
(60) Provisional application No. 61/860,421, filed on Jul. 31, 2013.

(51) Int. Cl. E05C 1/08

(52) U.S. Cl. CPC E05C 1/08
USPC 292/2

(57) ABSTRACT

An apparatus is presented for locking a lid to a body of a container. The apparatus includes a movable latch to open and close the lid. The apparatus also includes a strike positioned relative to the latch to lock the lid in a closed position and pivotally connected to a housing to move relative to the latch for opening the lid. The apparatus further includes a block slidably disposed within the housing to move between a first position when the container is in the upright or side position and a second position when the container is in the upside down position. The strike is operatively connected to the block to pivot to a first position to lock the lid to the body when the block is in its first position and to a second position to unlock the lid when the block is in its second position.

### CROSS-REFERENCE TO RELATED APPLICATIONS

This application claims priority to U.S. Provisional Application No. 61/860,421 filed on Jul. 31, 2013 and incorporated by reference herein in its entirety.

### BACKGROUND OF THE INVENTION

The present invention relates to latches for containers, and more particularly, to a latch for locking a lid to a body of a container.

There are previously known latches that are used to lock containers, such as trash containers, when in an upright position and to unlock the container when in an upside down position upon being emptied. However, in the event that the container falls over on one of its sides prior to being emptied, such latches may prematurely unlock the container. Thus, it would be advantageous to provide a latch that only unlocks the container in the upside down position upon being emptied, thereby avoiding unwanted emptying of the container in the surrounding area.

### BRIEF DESCRIPTION OF THE INVENTION

One embodiment of the present invention provides an apparatus for locking a lid to a body of a container. The apparatus includes a housing and a moveable latch that is operatively connected to the housing to open and close the lid. The apparatus also includes a strike positioned relative to the latch to lock the lid in a closed position and pivotally connected to the housing to move relative to the latch for opening the lid. The apparatus also includes a block slidably disposed within the housing to move between a first position when the container is in the upright or side position and a second position when the container is in the upside down position. The strike is operatively connected to the block such that the strike pivots between a first position to lock the lid to the body when the block is in its first position and a second position to unlock the lid from the body when the block is in its second position.

Another embodiment of the present invention provides an apparatus for locking a lid to a body of a container. The apparatus includes a housing and a moveable latch to open and close the lid and operatively connected to the housing. The apparatus also includes a strike positioned relative to the latch to lock the lid in a closed position and pivotally connected to the housing to move relative to the latch for opening the lid. The apparatus also includes a block slidably disposed within the housing to move between a first position when the container is in the upright or side position and a second position when the container is in the upside down position. The strike includes an arm and at least a portion of the arm is slidably received within a slot defined by the block such that the strike pivots between a first position to lock the lid to the body when the block is in its first position and a second position to unlock the lid from the body when the block is in its second position.

Another embodiment of the present invention provides an apparatus for locking a lid to a body of a container. The apparatus includes a housing and a moveable latch to open and close the lid and operatively connected to the housing. The apparatus also includes a strike positioned relative to the latch to lock the lid in a closed position and pivotally connected to the housing to move relative to the latch for opening the lid. The apparatus also includes a block slidably disposed within the housing to move between a first position when the container is in an upright or side position and a second position when the container is in an upside down position. The strike is operatively connected to the block such that the strike pivots between a first position to lock the lid to the body when the block is in its first position and a second position to unlock the lid from the body when the block is in its second position. The block includes a pair of grooves such that one or more movable stops are configured to move into one or more grooves to inhibit movement of the block from its first position when the container is in the upright or side position.

### BRIEF DESCRIPTION OF THE DRAWINGS

A more particular description of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a plan view of an apparatus for locking a lid to a body of a container according to the present invention;

FIG. 2 is an isolated view of a housing of the apparatus of FIG. 1;

FIG. 3 is a perspective exploded view of the housing of FIG. 2;

FIG. 4 is an exploded view of the housing of FIG. 2 when the container is in an upright position;

FIG. 5 is a bottom perspective view of a block slidably received within the housing of FIG. 4;

FIG. 6 is an exploded view of the housing of FIG. 2 when the container is in a first side position;

FIG. 7 is an exploded view of the housing of FIG. 2 when the container is in a second side position;

FIG. 8 is an exploded view of the housing of FIG. 2 when the container is in an upside down position;

FIG. 9 is a side view of the container of FIG. 1;

FIG. 10 is a top view of the container of FIG. 1;

FIG. 11 is a sectional view of the pitch of slanted ramps of the housing of FIG. 4 taken along the line 10-10;

FIG. 12 is an exploded view of an alternate apparatus for locking the lid to the body of the container in FIG. 1;

FIG. 13 is a perspective view of a container in a locked position with the alternate apparatus of FIG. 12;

FIG. 14 is a side sectional view of the alternate apparatus of FIG. 12 attached to an interior surface of the container of FIG. 13;

FIG. 15 is an isolated front view of an upper housing of the alternate apparatus of FIG. 12;

FIG. 16 is an exploded view of the upper housing of FIG. 15; and

FIG. 17 is a flowchart depicting a method for locking a lid to a body of a container.

### DETAILED DESCRIPTION OF THE INVENTION

In describing particular features of different embodiments of the present invention, number references will be utilized in relation to the figures accompanying the specification. Similar or identical number references in different figures may be utilized to indicate similar or identical components among different embodiments of the present invention.

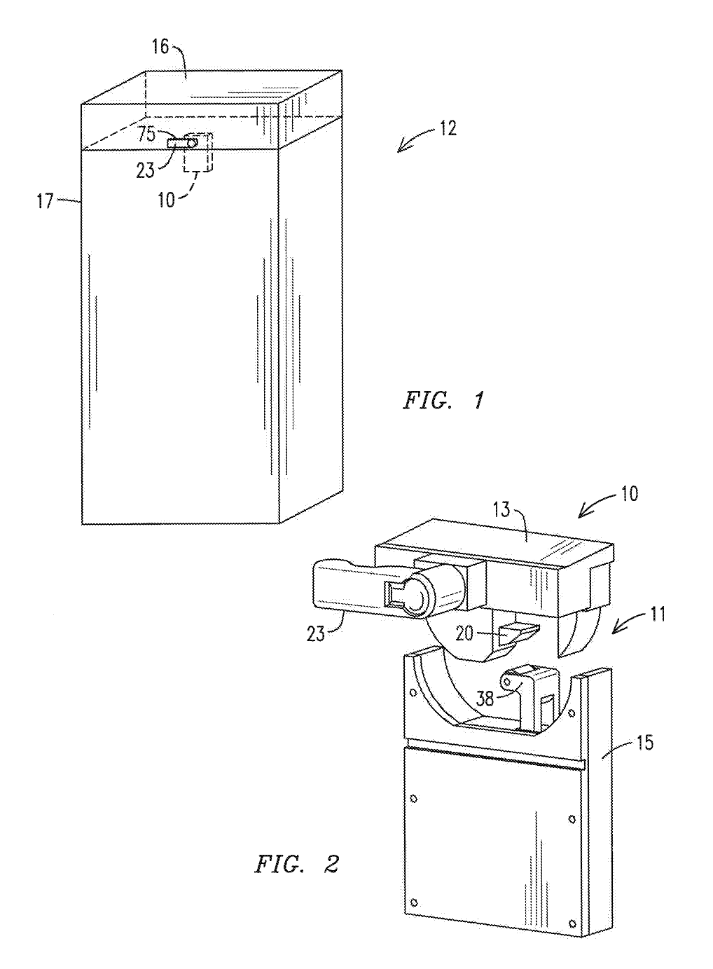

FIG. 1 illustrates an apparatus 10 for locking a lid 16 to a body 17 of a container 12, where the apparatus 10 is used to lock the lid 16 to the body 17 of the container 12 when the container 12 is in an upright position or a side position, and to unlock the lid 16 from the body 17 when the container 12 is in an upside down position, as discussed in greater detail below. In an exemplary embodiment, the container 12 may be a trash container. However, the embodiments of the present invention are not limited to trash containers and encompass any container whose lid is designed to be locked when the container is in an upright or a side position, such as a paint container, for example. As illustrated in FIG. 1, the apparatus 10 is secured to an inside surface of the container 12. However, the embodiments of the present invention is not limited to the apparatus 10 being secured to the inside surface of the container 12 and the apparatus 10 may be secured to an outer surface of the container 12, for example. Additionally, although FIG. 1 depicts the apparatus 10 secured to the container 12, the embodiments of the present invention is not limited to an apparatus that is configured to be used with containers 12, and includes an apparatus that may be used with any container which needs to be in a locked position when in an upright position or a side position and in an unlocked position when in an upside down position, for example.

FIG. 2 illustrates the apparatus 10 which includes a housing 11 comprising an upper housing 13 and a lower housing 15. A movable latch 20 is operatively connected to the upper housing 13 and is used to open and close the lid 16. A strike 38 is positioned relative to the movable latch 20 to lock the lid 16 in a closed position and is pivotally connected to the lower housing 15 to move relative to the latch 20 for opening the lid 16. In an exemplary embodiment, the latch 20 may be a cam bit and the strike 38 may be a roller, for example. Additionally, as illustrated in FIG. 2, the upper housing 13 includes an actuating handle 23 pivotally coupled to the latch 20 to move the latch 20 relative to the strike 38, to unlock the lid 16. The actuating handle 23 can be manually pivoted, in order to move the latch 20 and open the lid 16 of the container 12, in the event that a user wants to load the container 12. FIG. 1 depicts that the actuating handle 23 may be visible from an exterior of the container 12, since the actuating handle 23 may pass through an opening 75 in the lid 16. To manually open the container 12, the user may first pull the actuating handle 23 out of the opening 75 and subsequently rotate the actuating handle 23, to move the latch 20 out of engagement with the strike 38. Although FIGS. 1-2 illustrate that the actuating handle 23 may be used to manually open the container 12, other means for manually opening the container 12 may be used.

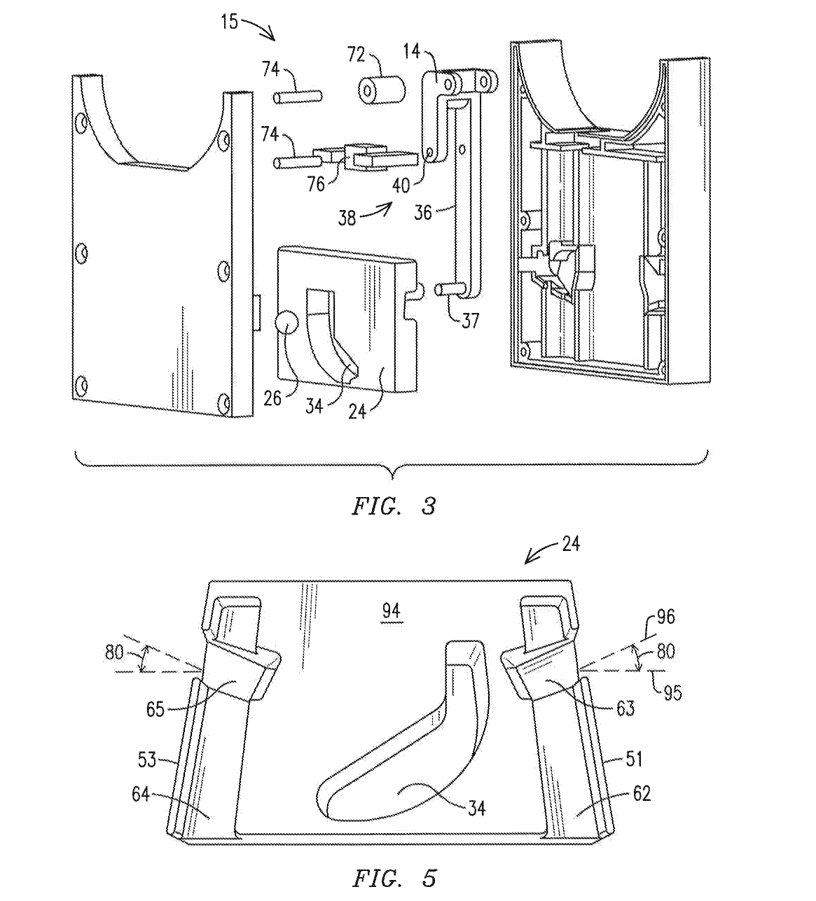

FIG. 3 illustrates an exploded view of the lower housing 15 in FIG. 2, and illustrates a block 24 that is slidably disposed within the lower housing 15. Additionally, as illustrated in FIG. 3, the strike 38 includes a latch receiving member 14 and a pivot arm 36 attached to the latch receiving member 14, where one portion or end 37 of the pivot arm 36 is disposed within the lower housing 15 and operatively connected to the block 24. As illustrated in FIG. 3, the latch receiving member 14 of the strike 38 is formed by passing a pin 74 through a latch roller 72, to secure the latch roller 72 to the strike 38. Additionally, the pivot arm 36 is rotatably fixed at a pivot point 40 to the lower housing 15 based on passing a pin 74 through a pivot block. 76 that is securely mounted within the lower housing 15. Indeed, FIGS. 2 and 3 merely illustrate one exemplary embodiment of the apparatus 10 and the apparatus of the present invention is not limited to the structural features depicted in FIGS. 2 and 3.

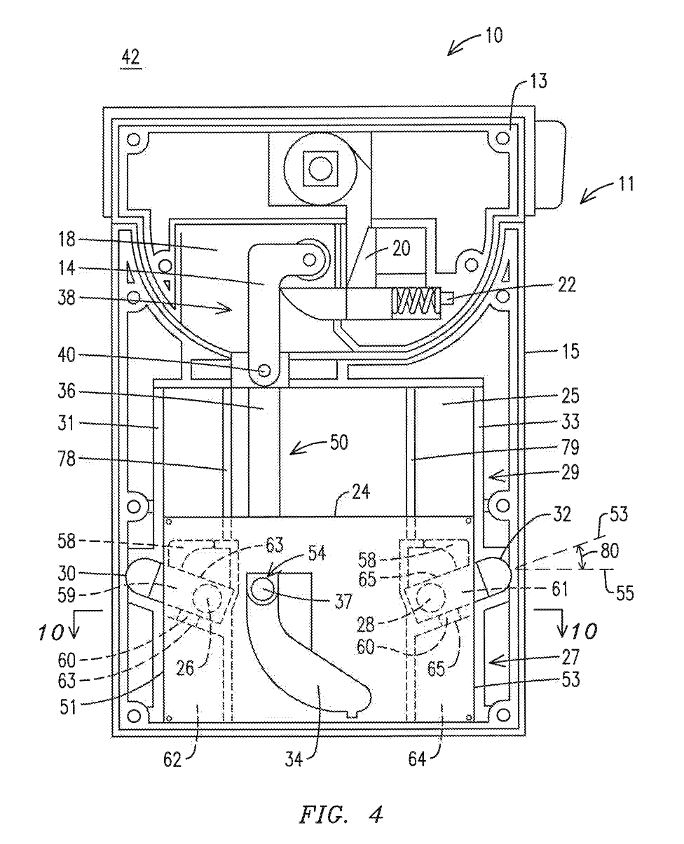

FIG. 4 illustrates an exemplary embodiment of the apparatus 10, including the upper housing 13 that is attached to the lid 16 of the container 12 and the lower housing 15 that is attached to the body 17 of the container 12. The apparatus 10 is shown when the container 12 is in an upright position 42. The upper housing 13 and the lower housing 15 of the apparatus 10 define an opening 18 therebetween in which the latch receiving member 14 and a portion of the latch 20 extends, due to the latch 20 being compressed by a spring 22 within the upper housing 13. However, the portion of the latch 20 may extend into the opening 18 by any other compressive element.

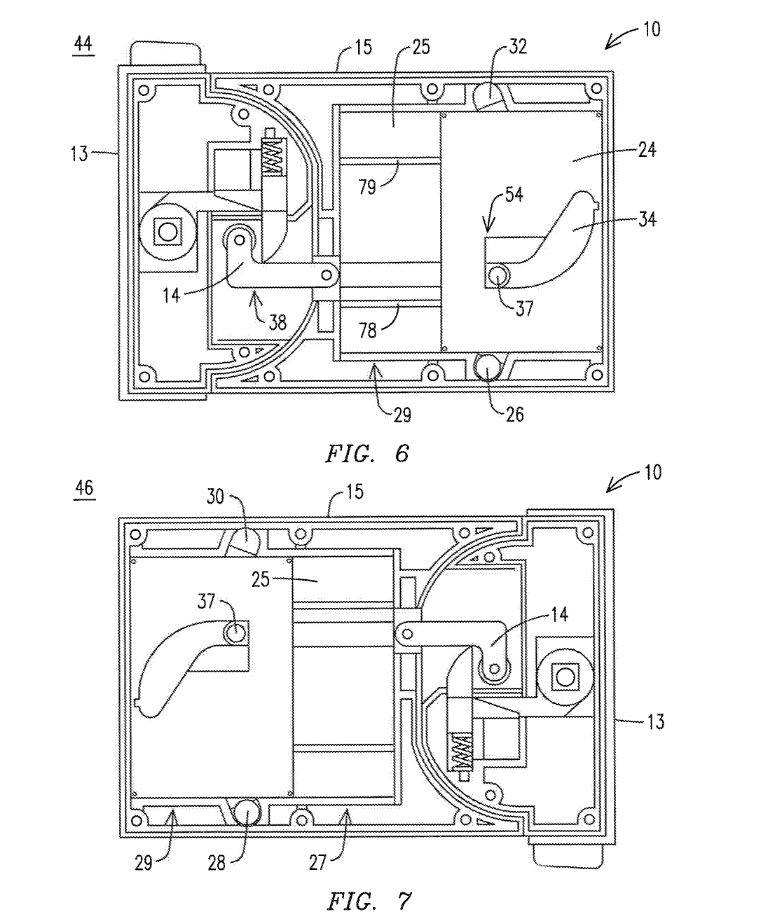

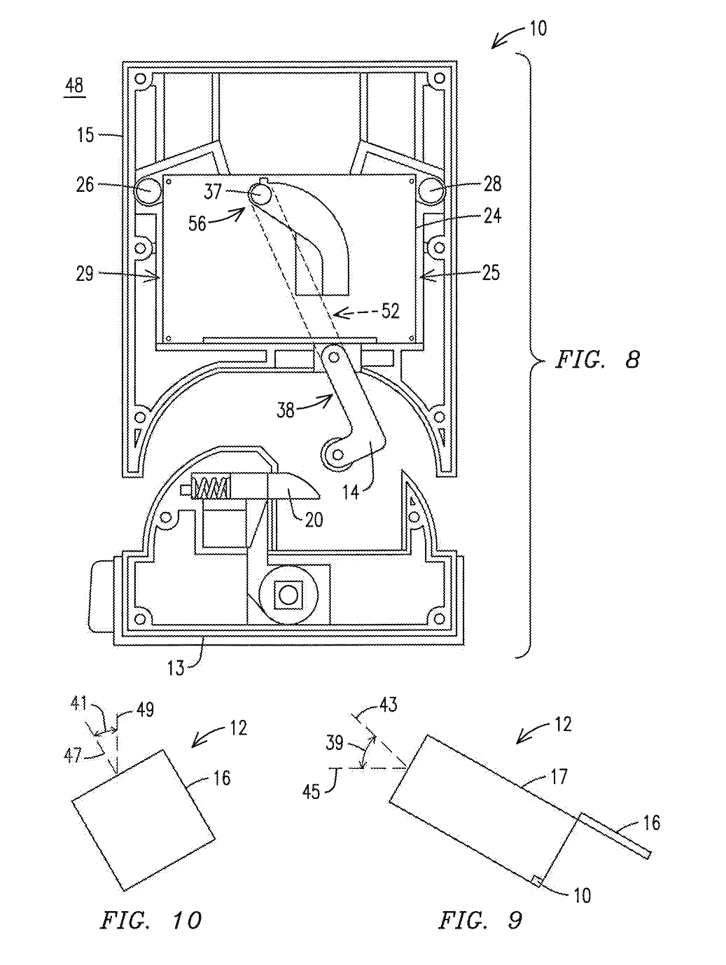

As further illustrated in FIG. 4, the apparatus 10 includes the weighted block 24 that is slidably received within a cavity 25 defined by the lower housing 15 to move between a first position 27 when the container is in the upright position 42 or a side position (FIGS. 6-7) and a second position 29 when the container 12 is in an upside down position (FIG. 8). A pair of side rails 31, 33 is provided on opposite sides of the lower housing 15, to provide surfaces to slidably engage outer block portions 51, 53 of the block 24, and thus accommodate the block 24 sliding within the cavity 25. Additionally, a pair of mid rails 78, 79 is provided within the lower housing 15, to support the block 24 as it slides within the cavity 25. As illustrated in FIG. 5, the block 24 includes a pair of grooves 62, 64 formed in an undersurface 94 of the block 24, to receive a pair of projections 58, 60 in the lower housing 15, as the block 24 slides within the cavity 25, to guide the block 24 along the cavity 25. As illustrated in FIG. 4, the projections 58, 60 are disposed between the side rails 31, 33 and the mid rails 78, 79 and are in a mating relationship with the grooves 62, 64 for aligned movement of the block 24 within the lower housing 15. The height of each mid rail 78, 79 is such that the outer block portions 51, 53 of the block 24 interface the side rails 31, 33 to further control alignment of the block 24 in the lower housing 15.

In order to lock the lid 16 of the container 12, the strike 38 is operatively connected to the block 24 such that the strike 38 pivots between a first position 50 (FIG. 4) to lock the lid 16 to the body 17 when the block 24 is in its first position 27 and a second position 52 (FIG. 8) to unlock the lid 16 from the body 17 when the block 24 is in its second position 29. The latch receiving member 14 extends into the opening 18 and engages the latch 20 of the upper housing 13, to securely lock the lid 16 of the container 12. The end 37 of the pivot arm 36 is received within a curved slot 34 in the block 24. When the container 12 is in the upright position 42 (FIG. 4) or a side position 44, 46 (FIGS. 6-7), the block 24 remains in the first position 27 of the cavity 25, and the end 37 is fixed at a first end 54 of the slot 34, to maintain the strike 38 in the first position 50 such that the latch receiving member 14 is engaged with the latch 20. When the container 12 is in the upside down position 48 (FIG. 8), the block 24 moves to the second position 29 of the cavity 25 and the end 37 is fixed at a second end 56 of the slot 34, to maintain the strike 38 in the second position 52 such that the latch receiving member 14 is disengaged from the latch 20.

As illustrated in FIG. 4, a pair of movable stops or ball bearings 26, 28 are positioned within a respective pair of ramps 30, 32 which are inclined. On each side of the lower housing 15, the pair of projections 58, 60 is positioned on either side of the ramps 30, 32. As illustrated in FIG. 4, in the upright position 42, the ball bearings 26, 28 move through a projection gap 59, 61 between the respective projections 58, 60 and into a pair of intersecting grooves 63, 65 in the block 24. As illustrated in FIG. 5, the intersecting grooves 63, 65 are formed along the undersurface 94 of the block 24, are aligned in a parallel direction with the respective ramps 30, 32 and intersect the grooves 62, 64 on the undersurface 94 of the block 24. As illustrated in FIG. 4, the ramps 30, 32 are aligned at a first angle 80, as measured between a normal direction 55 to the lower housing 15 surface and a ramp axis 57 of each slanted ramp 30, 32. As illustrated in FIG. 5, the intersecting grooves 63, 65 are similarly aligned at the first angle 80, as measured between a normal direction 95 to the block 24 surface and an axis 96 of each intersecting groove 63, 65. Thus, the intersecting grooves 63, 65 are parallel and aligned with the slanted ramps 30, 32, when the block 24 is positioned in the first position 27 of the cavity 25. By moving into the intersecting grooves 63, 65 on the undersurface 94 of the block 24, the ball bearings 26, 28 inhibit movement of the block 24 from the first position 27 into the second position 29 of the cavity 25, by preventing the intersecting grooves 63, 65 from passing the projection 58 of each ramp 30, 32. The slanted ramps 30, 32 each have a pitched surface so that the ball bearings 26, 28 remain disposed between the projections 58, 60, while the container 12 is in the upright position 42 or the side position 44, 46, and so that the ball bearings 26, 28 do not remain disposed between the projections 58, 60 while the container 12 is in the upside down position 48. The block 24 is configured so that the ball bearings 26, 28 may move in and out of position with the projections 58, 60, as the container 12 is moved between an upside down position and an upright or side position.

FIG. 6 illustrates an exemplary embodiment of the apparatus 10, when the container 12 is in a first side position 44, such as when the container 12 falls onto a first side, for example. In the first side position 44, the ball bearing 26 (that is on the same side of the apparatus 10 as the first side of the container 12) moves from the intersecting groove 63 of the block 24 and between the projections 58, 60 of the lower housing 15 out through the projection gap 59 and to an outside portion of the slanted ramp 30. In contrast, the ball bearing 28 remains in the intersecting groove 65 of the block 24 and between the projections 58, 60 of the lower housing 15 and within the inner portion of the slanted ramp 32. Since at least one ball bearing 28 remains between the projections 58, 60 of at least one slanted ramp 30, 32, the ball bearing 28 inhibits movement of the block 24 from the first position 27 into the second position 29 of the cavity 25 by preventing the intersecting grooves 63, 65 of the block 24 from passing the projections 58, 60 of the lower housing 15. Since the block 24 remains in the first position 27 of the cavity 25, the end 37 of the pivot arm 36 remains fixed at the first end 54 of the curved slot 34, thereby ensuring that the strike 38 remains in the first position 50 and the latch receiving member 14 remains engaged with the latch 20.

FIG. 7 illustrates a similar embodiment as FIG. 6, with the exception that the container 12 is in a second side position 46, such as when the container 12 falls onto a second side, for example. Unlike the first side position 44 of FIG. 6, the ball bearing 28 (that is on the same side of the apparatus 10 as the second side of the container 12) moves from the intersecting groove 65 of the block 24 and between the projections 58, 60 of the lower housing 15 out through the projection gap 61 and to an outside portion of the slanted ramp 32. In contrast, the ball bearing 26 remains in the intersecting groove 63 of the block 24 and between the projections 58, 60 of the lower housing 15 and within the inner portion of the slanted ramp 30. Since at least one ball bearing 26 remains between the projections 58, 60 of at least one of the slanted ramps 30, 32, the ball bearing 26 inhibits movement of the block 24 from the first position 27 into the second position 29 by preventing the intersecting grooves 63, 65 of the block 24 from passing the projections 58, 60 of the lower housing 15. Since the block 24 remains in the first position 27 of the cavity 25, the end 37 of the pivot arm 36 remains fixed at the first end 54 of the curved slot 34, thereby ensuring that the strike 38 remains in the first position 50 and the latch receiving member 14 remains engaged with the latch 20.

FIG. 8 illustrates an exemplary embodiment of the apparatus 10, when the container 12 is in the upside down position 48, such as when the container 12 is picked up by an automatic device and turned upside down to empty the contents of the container 12, for example. Unlike the upright position 42, first side position 44 and second side position 46 of FIGS. 5-7, upon turning the container 12 to the upside down position 48, both of the ball bearings 26, 28 move from the respective intersecting grooves 63, 65 of the block 24 and between the projections 58, 60 of the lower housing 15 out through the respective projection gaps 59, 61 and to an outside portion of the respective ramps 30, 32. Since both of the ball bearings 26, 28 move to the outside portion of the slanted ramps 30, 32 and thus no ball bearings 26, 28 are positioned within the intersecting grooves 63, 65 of the block 24 and between the projections 58, 60 of the lower housing 15, the intersecting grooves 63, 65 can move beyond the projections 58, 60. Thus, the projections 58, 60 are free to move within the grooves 62, 64 of the block 24 and the block 24 is permitted to move from the first position 27 of the cavity 25 to the second position 29 of the cavity 25. Additionally, as illustrated in FIG. 8, as the block 24 moves from the first position 27 to the second position 29 of the cavity 25, the end 37 of the pivot arm 36 moves from the first end 54 to the second end 56 of the curved slot 34, thereby causing the strike 38 to rotate at the pivot point 40 to the second position 52, so that the latch receiving member 14 disengages the latch 20 of the upper housing 13, thereby unlocking the lid 16 of the container 12.

FIG. 9 illustrates the container 12 being emptied by tilting the container 12 at a vertical tilt threshold angle 39, as measured between a horizontal direction 45 and a longitudinal axis 43 of the container 12. The vertical tilt threshold angle 39 is the minimum angle at which the apparatus 10 will unlock the lid 16 of the container 12. Thus, in an exemplary embodiment of the present invention, the upside down position 48 of the container 12 is defined as a tilt angle of the container 12 which exceeds the vertical tilt threshold angle 39, for example. However, the upside down position 48 of the container 12 is not limited to this exemplary embodiment. The vertical tilt threshold angle 39 is based on the first angle 80 (FIG. 4) of the slanted ramps 30, 32. In an exemplary embodiment, the vertical tilt threshold angle 39 increases and decreases, based on a respective increase or decrease of the first angle 80 of the slanted ramps 30, 32. In another exemplary embodiment, the vertical tilt threshold angle 39 is proportional to the first angle 80 of the slanted ramps 30, 32. In another exemplary embodiment, the vertical tilt threshold angle 39 is equal to the first angle 80 of the slanted ramps 30, 32. As appreciated by one skilled in the art, the automatic devices which are used to empty containers 12 may not rotate the container 12 into an upside down position 48 where the vertical tilt threshold angle 39 is 90 degrees, and thus the first angle 80 of the apparatus 10 may be adjusted such that the vertical tilt threshold angle 39 is less than 90 degrees. In an exemplary embodiment, the first angle 80 is adjusted such that the vertical tilt threshold angle 39 is less than 45 degrees. These exemplary angles are merely one variation of a design of the apparatus 10, and the first angle 80 may be adjusted to be any angle, provided that the apparatus 10 unlocks the lid 16 of the container 12 when the container 12 is emptied.

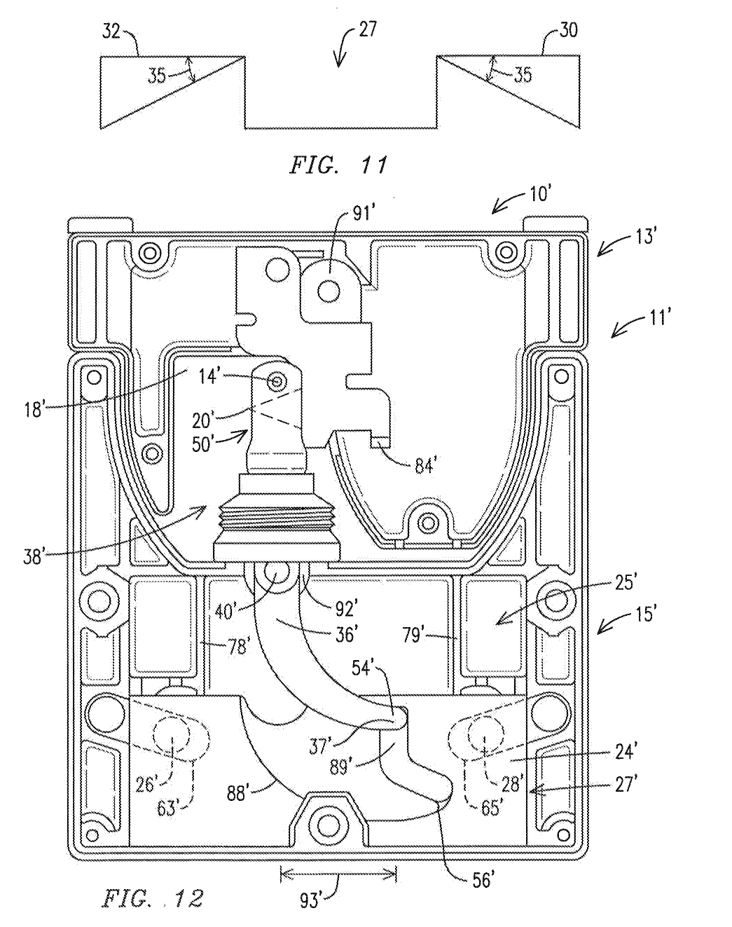

FIG. 10 illustrates a top down view of the lid 16 of the container 12 as it is being emptied. As illustrated in FIG. 10, the container 12 is emptied along a tilt axis 49 (i.e., rotated from the upright position 42 to the upside down position 48 along the tilt axis 49). Ideally, the tilt axis 49 corresponds with a normal direction 47 to a side of the lid 16 with hinges, so that the lid 16 readily opens in the upside down position 48. However, as illustrated in FIG. 10, some emptying devices may grasp the container 12 such that a side tilt threshold angle 41 is formed between the tilt axis 49 and the normal direction 47 while emptying the container 12. The side tilt threshold angle 41 is defined as a maximum threshold between the tilt axis 49 and the normal direction 47, at which the apparatus 10 will unlock the lid 16 in the upside down position 48. Thus, the lid 16 of the container 12 will remain locked and closed in the upside down position 48, if the angle between the tilt axis 49 and the normal direction 47 exceeds the side tilt threshold angle 41. The side tilt threshold angle 41 is adjusted, based on an angular configuration of the slanted ramps 30, 32 of the apparatus 10. FIG. 11 illustrates a schematic sectional view of the slanted ramps 30, 32, illustrating the pitch of the ramps 30, 32. As illustrated in FIG. 11, the slanted ramps 30, 32 are inclined at a second angle 35 in a transverse dimension orthogonal to the first angle 80 of the slanted ramps 30, 32 inclined in a longitudinal dimension of the apparatus 10. In an exemplary embodiment, the side tilt threshold angle 41 increases and decreases, based on a respective increase or decrease in the second angle 35 of the slanted ramps 30, 32. In another exemplary embodiment, the side tilt threshold angle 41 is proportional to the second angle 35 of the slanted ramps 30, 32, In another exemplary embodiment, the side tilt threshold angle 41 is equal to the second angle 35 of the slanted ramps 30, 32. In another exemplary embodiment, both the side tilt threshold angle 41 and the second angle 35 are less than 30 degrees, for example. These exemplary angles are merely one variation of a design of the apparatus 10, and the second angle 35 may be adjusted to be any angle, provided that the apparatus 10 unlocks the lid 16 of the container 12 when the container 12 is emptied.

FIG. 12 illustrates an alternate embodiment of an apparatus 10′ including a housing 11′ comprising an upper housing 13′ and a lower housing 15′, which operate in a similar manner as the upper housing 13 and the lower housing 15 of the apparatus 10 discussed above in relation to FIGS. 2-8, except with regard to the specific features discussed herein. As illustrated in FIG, 12, a movable latch 20′ is operatively connected to the upper housing 13′ and is used to open and close the lid 16. The apparatus 10′ includes a strike 38′ positioned relative to the latch 20′ to lock the lid 16 in a closed position and pivotally connected to the lower housing 15 to move relative to the latch 20′ for opening the lid 16. As illustrated in FIG. 12, the strike 38′ includes a latch receiving member 14′ at an end of a pivot arm 36′ and the latch receiving member 14′ engages the latch 20′ when the strike 38′ is in a first position 50′. In an exemplary embodiment, the latch receiving member 14′ may be a roller, for example. As with the apparatus 10 discussed above in relation to FIGS. 2-8, the strike 38′ remains in the first position 50′ when the container 12 is in the upright position or in a side position and the strike 38′ moves to a second position Where the latch receiving member 14′ disengages the latch 20′ when the container 12 is in the upside down position.

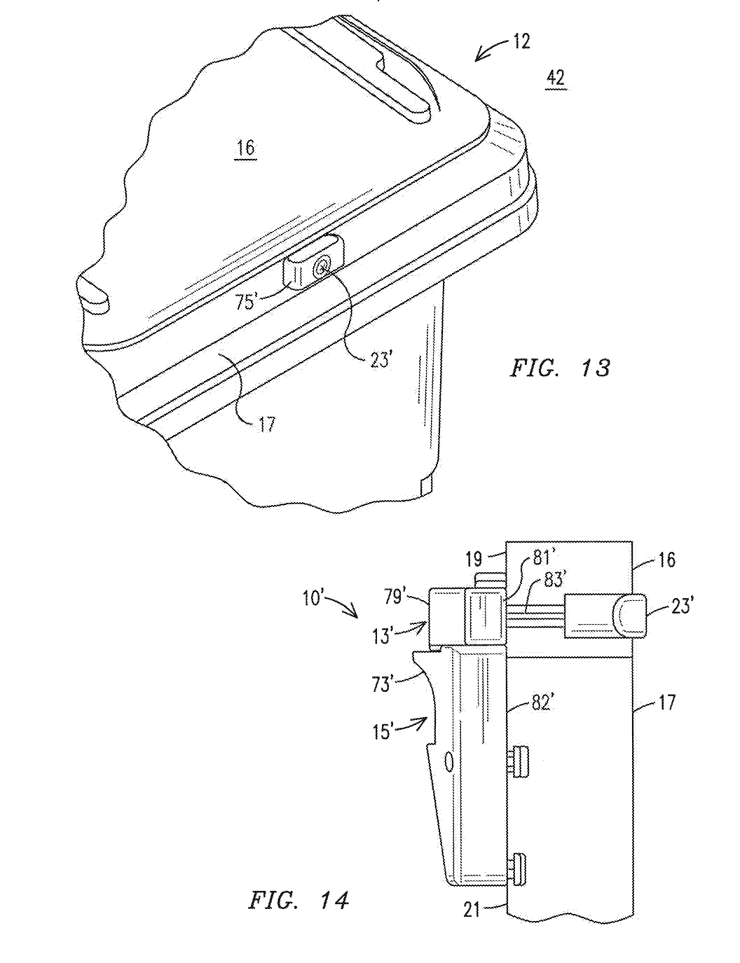

FIG. 13 illustrates the container 12 including the lid 16 and the body 17, where the lid 16 defines an opening 75′ that is sized to receive an actuating handle 23′ of the upper housing 13′ of the apparatus 10′. FIG. 14 illustrates the apparatus 10′, including the upper housing 13′ with a flat side 81′ secured to an inner surface 19 of the lid 16 and the lower housing 15′ with a flat side 82′ secured to an inner surface 21 of the body 17. The upper housing 13′ and the lower housing 15′ each include a respective curved side 79′, 73′ facing an interior of the container 12. However, the upper and lower housings 13′, 15′ need not include a curved side facing an interior of the container 12, and both sides of the apparatus 10′ may be flat sides, for example.

As further illustrated in FIG. 14, the actuating handle 23′ is on an end of a handle stem 83′ that extends through the opening 75′ in the lid 16, such that the handle stem 83′ rotatably couples the handle 23′ to the latch 20′ of the upper housing 13′. To manually unlock the container 12, a user initially pulls the handle 23′ out of the opening 75′ of the lid 16 and subsequently rotates the handle 23′, to disengage the latch 20′ of the upper housing 13′ from the latch receiving member 14′ of the strike 38′ of the lower housing 15′ and unlock the lid 16. However, the handle need not be rotatably coupled to the latch 20′ and may be any type of actuating handle, that is configured to move the latch 20′ out of engagement with the latch receiving member 14′.

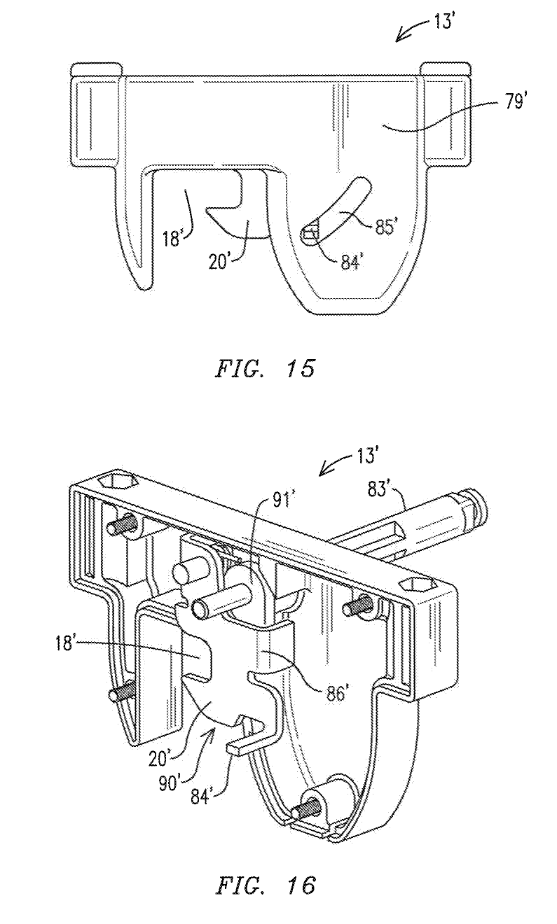

As illustrated in FIGS. 15-16, in an emergency situation, such as if an individual accidentally gets locked inside the container 12, a tab 84′ is provided on the curved side 79′ of the upper housing 13′ facing the interior of the container 12. The tab 84′ is positioned within a curved slot 85′ defined by curved side 79′ of the upper housing 13′, so that upon moving the tab 84′ across the slot 85′, the movable latch 20′ rotates out of engagement with the latch receiving member 14′ of the strike 38′ of the lower housing 15′, and the lid 16 can be opened. However, other arrangements may be provided, to unlock the container 12 in an emergency situation. For example, an individual positioned inside the container 12 may unlock the container 12 by other means, such as by directly contacting the latch 20′ and moving the latch 20′ out of the opening 18′ and out of engagement with the latch receiving member 14′ of the strike 38′, for example.

As further illustrated in FIG. 16, a latch element 90′ is disposed in the upper housing 13′, and includes the latch 20′, the tab 84′ and a flange 86′ rotatably coupled to a rotatable base 91′ of the handle stem 83′. Upon rotation of the actuating handle 23′ and the handle stern 83′, the base 91′ rotates the flange 86′, which in-turn rotates the latch 20′ out of engagement with the latch receiving member 14′ of the strike 38′. Additionally, since the base 91′ and the flange 86′ are discrete, the latch 20′ may be rotated independent of the handle 23′ and the handle stem 83′, such as by moving the tab 84′ within the slot 85′, for example.

FIG. 12 illustrates the lower housing 15′ of the apparatus 10′, where the pivot arm 36′ of the strike 38′ is pivotally connected to the lower housing 15′ at the pivot point 40′. The pivot arm 36′ is passed through a seal, such as a flexible gasket 87′ positioned on a top surface of the lower housing 15′, such that the flexible gasket 87′ prevents debris from entering a gap 92′ between the pivot arm 36′ and the lower housing 15′ at the pivot point 40′. In an exemplary embodiment, the flexible gasket 87′ may be made from a rubber material, for example. In addition to shielding debris from entering the gap 92′ between the pivot arm 36′ and the lower housing 15′, the flexible gasket 87′ may accommodate rotation of the strike 38′. In an exemplary embodiment, a diameter of the flexible gasket 87′ may be larger than a diameter of an opening in the lower housing 15′ through which the pivot arm 36′ is passed.

FIG. 12 further illustrates that the lower housing 15′ includes a weighted block 24′ within a cavity 25′ that operates in a similar manner as the block 24 positioned within the cavity 25 of the lower housing 15 previously discussed in relation to FIGS. 4-8. As illustrated in FIG. 12, when the container 12 is in the upright position, the block 24′ remains in a first position 27′ of the cavity 25′, and an end 37′ of the pivot arm 36′ is fixed at a first end 54′ of a curved slot 34′, to maintain the strike 38′ in the first position 50′ engaged with the latch 20′. When the container 12′ is moved to an upside down position, the end 37′ of the pivot arm 36′ moves from the first end 54′ to the second end 56′ of the curved slot 34′, the strike 38′ is moved out of the first position 50′ and out of engagement with the latch 20′ and a curved recess 88′ of the block 24′ is shaped such that the curved pivot arm 36′ is received within the curved recess 88′. Since the pivot arm 36′ is received within the curved recess 88′ of the block 24′, the lower housing 15′ has a reduced thickness. The curvature of the pivot arm 36′ is adjusted, so the pivot arm 36′ avoids contact with the lower housing 15′ adjacent to the pivot point 40′, as the strike 38′ rotates out of engagement with the latch 20′. Additionally, the curvature of the pivot arm 36′ enhances the strength of the arm 36′ and increases the torque applied at the pivot point 40′. Additional torque at the pivot point 40′ is also provided, by positioning the curved slot 34′ within the block 24′ at a lateral distance 93′ from the pivot point 40′ and thus increasing the separation between the pivot point 40′ and the curved slot 34′.

When the container 12′ is in an upright or a side position, and one or more of the ball bearings 26′, 28′ are positioned within the intersecting grooves 63′, 65′ of the block 24′, the block 24′ may shift up and down by a minimal threshold distance within the first position 27′, based on the sizing of the ball bearings 26′, 28′ within the intersecting grooves 63′, 65′ of the block 24′. As illustrated in FIG. 12, the curved slot 34′ includes a straight section 89′adjacent to the first end 54′ of the slot 34′. As the end 37′ of the pivot arm 36′ moves within the straight section 89′, the pivot arm 36′ does not experience a lateral shift. The straight section 89′ is sized to be greater than the minimal threshold distance of the block 24′. Thus, the shifting of the block 24′ up and down within the first position 27′ by the minimal threshold distance will not cause the strike 38′ to rotate out of engagement with the latch 20′. In an exemplary embodiment, the straight section 89′ may be 8 millimeters (mm) in length, and the vertical threshold distance may be 4 mm, for example.

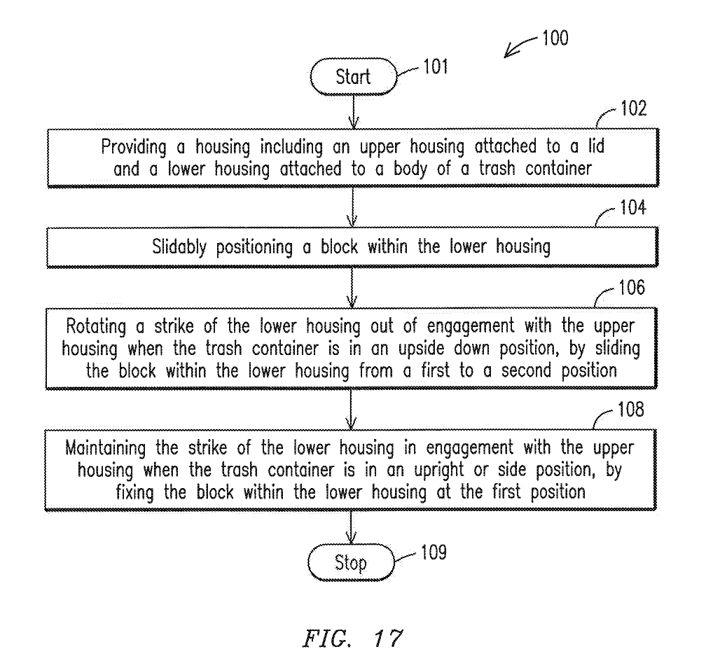

FIG. 17 illustrates a flowchart depicting a method 100 for locking the lid 16 to the body 17 of the container 12. The method 100 begins at 101 by providing 102 the housing 11 including the upper housing 13 attached to the lid 16 and the lower housing 15 attached to the body 17 of the container 12. The method 100 further includes slidably positioning 104 the block 24 within the lower housing 15. The method 100 further includes rotating 106 the strike 38 of the lower housing 15 out of engagement with the upper housing 13 when the container 12 is in an upside down position, where the rotating 106 step includes sliding the block 24 from the first position 27 to the second position 29 within the lower housing 15. The method 100 further includes maintaining 108 the strike 38 of the lower housing 15 in engagement with the upper housing 13 when the container 12 is in an upright position 42 or a side position 44, 46, where the maintaining 108 step includes fixing the block 24 at the first position 27 within the lower housing 15, before ending at 109.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. An apparatus for locking a lid to a body of a container, said apparatus comprising:
a housing;
a movable latch to open and close the lid and operatively connected to the housing;
a strike positioned relative to the latch to lock the lid in a closed position and pivotally connected to the housing to move relative to the latch for opening the lid; and
a block slidably disposed within the housing to move between a first position when the container is in an upright or side position and a second position when the container is in an upside down position;
wherein the strike is operatively connected to the block such that the strike pivots between a first position to lock the lid to the body when the block is in its first position and a second position to unlock the lid from the body when the block is in its second position.

2. The apparatus of claim 1, wherein the strike includes a latch receiving member and an arm attached to the latch receiving member and at least a portion of the arm is disposed within the housing and operatively connected to the block.

3. The apparatus of claim 2, wherein at least the portion of the arm is slidably received within a slot defined by the block to move from a first end of the slot when the block is in its first position to a second end of the slot when the block is in its second position.

4. The apparatus of claim 3, wherein the housing comprises:
an upper housing and the latch is operatively connected to the upper housing;
a lower housing in which the block and at least the portion of the arm are disposed;
wherein the upper and lower housing define an opening therebetween in which the latch receiving member and a portion of the latch are positioned to lock the lid.

5. The apparatus of claim 4, further comprising an actuating handle coupled to the latch to move the latch relative to the strike to unlock the lid.

6. The apparatus of claim 1, wherein the block includes a pair of grooves, and wherein said housing includes a pair of projections sized to be received within each groove for aligned movement of the block within the housing.

7. The apparatus of claim 6, further comprising a pair of movable stops within the housing, wherein upon the container being in the upright or side position, at least one of the movable stops is configured to move into at least one of the grooves to inhibit movement of the block out of its first position.

8. The apparatus of claim 7, wherein upon the container being in the upside down position, the pair of movable stops are configured to move out of the pair of grooves to permit movement of the block from its first position to its second position.

9. The apparatus of claim 7, further comprising a pair of ramps within the housing to receive the pair of movable stops, wherein said block includes a pair of intersecting grooves along an undersurface of the block, and wherein the at least one movable stop is configured to move along at least one of the ramps and at least one of the intersecting grooves and into the at least one groove to inhibit movement of the block out of the first position.

10. The apparatus of claim 9, wherein the pair of ramps and the pair of intersecting grooves are aligned in a parallel direction.

11. The apparatus of claim 9, wherein the pair of projections of the housing are positioned on opposite sides of the pair of ramps and the pair of intersecting grooves when the block is in the first position such that the at least one movable stop is positioned between the pair of projections to inhibit movement of the block out of its first position.

12. The apparatus of claim 9, wherein the pair of ramps are inclined at a first angle, wherein the upside down position of the container is based on a vertical tilt angle of the container in excess of the first angle.

13. An apparatus for locking a lid to a body of a container, said apparatus comprising:
a housing;
a movable latch to open and close the lid and operatively connected to the housing;
a strike positioned relative to the latch to lock the lid in a closed position and pivotally connected to the housing to move relative to the latch for opening the lid; and
a block slidably disposed within the housing to move between a first position when the container is in an upright or side position and a second position when the container is in an upside down position;
wherein the strike includes an arm and at least a portion of the arm is slidably received within a slot defined by the block such that the strike pivots between a first position to lock the lid to the body when the block is in its first position and a second position to unlock the lid from the body when the block is in its second position.

14. The apparatus of claim 13, wherein said housing comprises:
a lower housing in which the block and at least the portion of the arm are disposed; and
an upper housing and the latch is operatively connected to the upper housing;
an actuating handle coupled to the latch to move the latch relative to the strike to unlock the lid.

15. The apparatus of claim 13, wherein said housing comprises:
a lower housing in which the block and the at least portion of the arm are disposed; and
an upper housing and the latch is operatively connected to the upper housing, said upper housing including a first side defining a slot facing an interior of the container, and a tab slidably received within the slot, said tab coupled to the latch to move the latch relative to the strike to unlock the lid.

16. The apparatus of claim 13, further comprising a seal mounted to a surface of the housing to prevent debris from entering a gap between the strike and the housing.

17. The apparatus of claim 13, wherein the block defines a recess shaped to receive at least the portion of the arm upon movement of the block into the second position.

18. An apparatus for locking a lid to a body of a container, said apparatus comprising:
a housing;
a movable latch to open and close the lid and operatively connected to the housing;
a strike positioned relative to the latch to lock the lid in a closed position and pivotally connected to the housing to move relative to the latch for opening the lid; and
a block slidably disposed within the housing to move between a first position when the container is in an upright or side position and a second position When the container is in an upside down position;
wherein the strike is operatively connected to the block such that the strike pivots between a first position to lock the lid to the body when the block is in its first position and a second position to unlock the lid from the body when the block is in its second position;
wherein said block includes a pair of grooves such that at least one movable stop is configured to move into at least one of the grooves to inhibit movement of the block from its first position when the container is in the upright or side position.

19. The apparatus of claim 18, wherein the at least one movable stop is configured to move out of the at least one groove to permit movement of the block from the first position to the second position when the container is in the upside down position.
